(19) United States
(12) Patent Application Publication
(10) Pub. No.: US 2012/0168057 A1
(43) Pub. Date: Jul. 5, 2012

(54) METHOD OF VIBRATION WELDING

(75) Inventors: Shuji KANAMOTO, Tokyo (JP); Ryutaro NISHIBORI, Tokyo (JP); Takaaki NAGATA, Tokyo (JP); Hisashi MASUDA, Tokyo (JP); Masato TANAKA, Tokyo (JP)

(73) Assignee: HONDA MOTOR CO., LTD., Tokyo (JP)

(21) Appl. No.: 13/310,274

(22) Filed: Dec. 2, 2011

(30) Foreign Application Priority Data
Dec. 6, 2010 (JP) 2010-271539

(51) Int. Cl. B32B 37/06; B32B 37/08

(52) U.S. Cl. 156/73.1

(57) ABSTRACT

[Object]

When welding a pair of members made from resin, to limit a distortion being formed in a product after welding, and prevent a quality reduction in the visual appearance.

[Means for solving problem]

Bring together the surfaces of a pair of members 1, 2 which are going to be welded, then catch and clamp the members 1, 2 by upper jig 3 and lower jig 4 of the vibration welder, and melt the surfaces to be welded by pressing together the pair of members, increasing driving power and generating a relative movement by vibrating both simultaneously, and cool the melted portion by stopping the vibration and welding the melted portion, and, in the process of cooling, reduce the driving power to a predetermined pressure force.

### FIELD OF THE INVENTION

This invention relates to a method of vibration welding which is effective to inhibit the formation of a distortion in a weak area, for example, when welding an air bag cover for vehicles to an instrument panel by vibration.

### BACKGROUND ART

Conventionally, when bonding a main body of an air bag cover and an accommodation case made from resin containing an air bag which protects the driver and/or passengers of the vehicle, a method of vibration welding is used, this method is to abut the surfaces of the two members that are going to be welded, and to provide relative vibration in the condition of adding pressure force, thus making the abutting parts melt by frictional heat. In such an vibration welding, in order to ensure the welding of the members where the shape of one of the members is curved, form a rib (protruding portion) for welding to one of the members to be welded, and make the tip region of the lib support the shape of the other member to be welded. (For example, Prior Art 1)

Also, a technique for improving the strength of the welding in an vibration welding, add vibration under the condition when pressure is first applied to the members, immediately gradually reduce the applied pressure, and within a predetermined time (0.5-5 seconds), arrive at the second applied pressure force (⅘-⅕ of the first applied pressure), maintain a pressure contact, add vibration for a predetermined time and weld (For example, Prior art 2), and a technique in vibration welding which reduces generated abrasion powder before the abutting surface melts. (For example, Prior art 3)

### PRIOR ART

### Patented Documents

[Prior Art 1 ] Japanese Patent Application Publication Laid Open No. 2008-114747

[Prior Art 2 ] Japanese Patent Publication No. 3211712

[Prior Art 3 ] Japanese Patent Application Publication Laid Open No. 2010-149424

### DISCLOSURE OF INVENTION

### Problems Solved by the Invention

In the case of the Prior arts, after stopping the vibration, and cooling off under a maintained pressure, the melted portion solidifies. Therefore, sufficient weld strength in the melted portion is provided. However, for example, in the case of an air bag cover the tear-line of which is formed of thin thickness for cover separation at the appointed place, there is a problem in that stress concentrates on weak parts such as the tear-line, and a distortion will be generated.

When solidification takes place with such distortions remaining a distortion trace appears as a visible irregularity.

Also, as described in the above mentioned Prior art 2, when there is a weak part/area in a member to be welded, any distortion cannot be resolved in the middle of an vibration process even using the technique to reduce the force power for the second applied pressure.

Therein, the purpose of the present invention is to limit a distortion being formed in a product after welding, and prevent a quality reduction in the visual appearance.

Particularly, prevent a distortion formation when the members to be welded have a thin thickness weak area.

### Means For Solving Problems

In order to solve the above-mentioned problems, a method of vibration welding of the present invention comprising;

A process for bringing together the surfaces of a pair of members to be welded.

A process of vibration: to melt the surfaces to be welded by pressing together the pair of members, increasing driving power and generating a relative movement by vibrating both simultaneously.

A process of cooling: to cool the melted portion by stopping the vibration and welding the melted portion.

And in the process of cooling, reduce the driving power to a predetermined pressure force.

According to the present invention, melt surfaces to be welded by the frictional heat of the vibration, and stop the vibration when the driving force of the pressure being applied to the member reaches a predetermined level, and shift to a process of cooling. During the process of vibration, the original driving power is maintained, accordingly, it can improve frictional heat effectively. Also, in the process of cooling, by reducing the driving power to a predetermined pressure force, it is hard for a distortion to occur.

For example, 0.05-0.35 Mpa degree is preferred as a reduction of the driving power, when the driving power during the vibration process is 0.44 MPa.

And it is preferable that the reduction of the driving power is performed as soon as the vibration process has finished.

Herein, “the reduction of the driving power is performed as soon as the vibration process has finished” means that it is not necessary to reach the limit of the desired driving power in order to reach the melting point, the driving power should be lower than the driving power in the vibration before the temperature of the portion being melted reaches melting point.

Because, under the condition where the driving power is maintained for a long time after the frictional heat has dissipated, the distortion of the compression direction is greatly increased, as a result, the final distortion is magnified when the melted portion solidifies.

Also, the reduction of the driving power in the cooling process is effective for the prevention of distortion, particularly when there is a weakness in a thin part of either of the members to be welded.

### Effects of the Invention

In an vibration welding method, it can prevent deficiencies in the visual quality due to the generation of a distortion, by reducing the driving power before the cooling process that occurs after the vibration process has finished.

When after an vibration process is finished, start to reduce the driving power immediately, this is effective for the prevention of distortions, and it is more effective when there is a weakness in a thin part of the members to be welded.

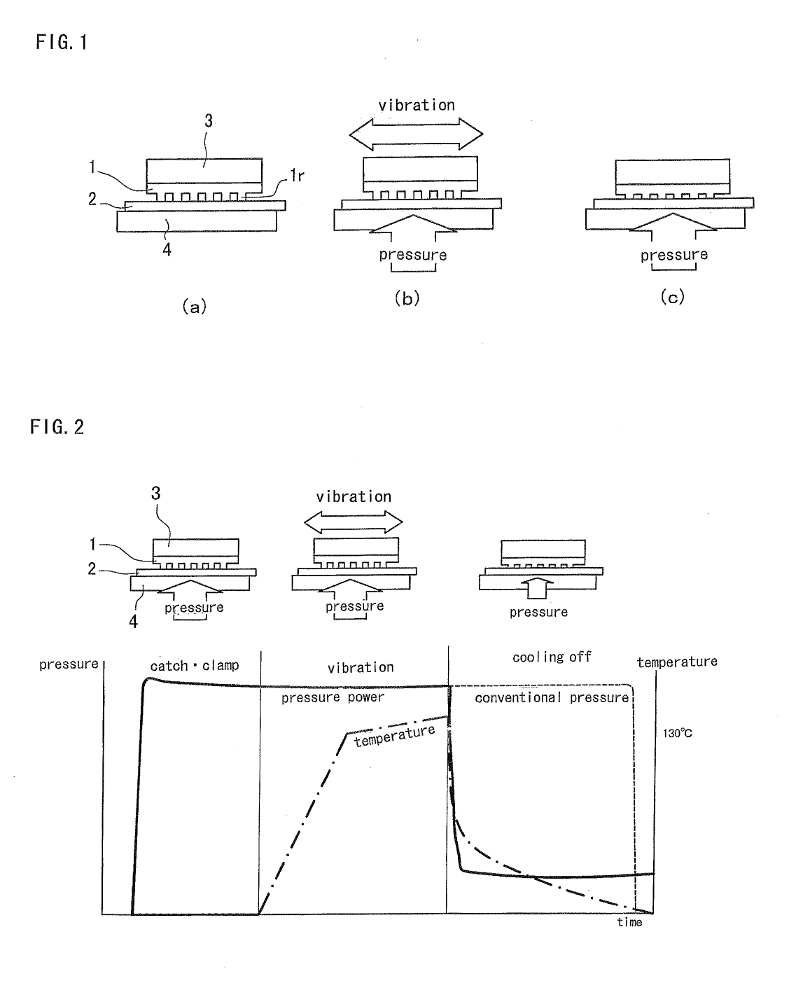

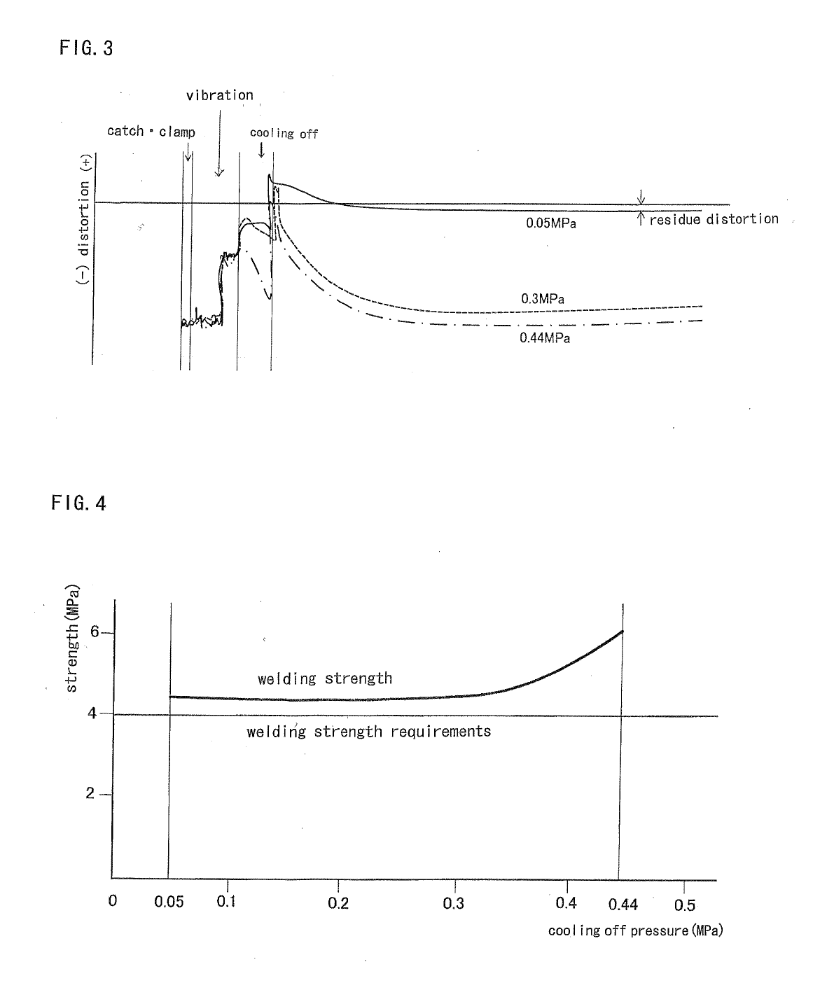

### BRIEF DESCRIPTION OF THE DRAWINGS

[ FIG. 1] A figure explaining a general vibration welding method

[ FIG. 2] A figure explaining an vibration welding method of the present invention.

[ FIG. 3] A figure showing experimental data which measured the quantity of distortion of the weak part at the time of cooling.

[ FIG. 4] A figure showing the relationship between the driving power at the time of cooling and the strength to the weld.

### BEST MODE FOR CARRYING OUT THE INVENTION

A method of vibration welding concerning the present invention, for example, when attaching the parts associated with an air bag to protect the driver and/or passengers of a vehicle by vibration welding, which prevents the generation of a distortion to a product after welding and prevents a reduction in the visual quality. Particularly, even if there is a weakness in the thinnest part of the thickness, such as tear-lines, stress is not concentrated in the weak part, and a distortion does not occur.

Based on FIG. 1, explain the abstract of the general point of the vibration welding. As shown in (a), bring together the surfaces of a pair of members 1, 2 which are going to be welded, then catch and clamp the members 1, 2 by upper jig 3 and lower jig 4 of the vibration welder.

Herein, for example, an vibration source (not shown in Fig) is connected to upper jig 3, the vibration source provides vibration to upper member 1. and a pressure application source (not shown in Fig) is connected to upper jig 4, the pressure application source pushes up the lower member 2, and provides urging driving power to both members 1, 2.

Also, a plural number of projection ribs (protruding portions) 1r for welding are provided on the surface of upper member 1, an vibration is given to the surface.

As shown in (b), when clamping the members 1 and 2 by the upper jig 3 and lower jig 4 of the vibration welder, the lower jig 4 increases pressure force and the upper jig 3 vibrates the upper member 1.

Then, a frictional heat is generated between the rib 1r of member 1 and the abutment with member 2, and the rib 1r are melted, the lower member 2 is pushed above. and as shown in (c), the vibration by the upper jig 3 is stopped and the cooling of the melted area is started.

In the above cooling process shown in (c), conventionally, a driving pressure power is maintained during an vibration process, but according to the present invention, driving pressure power is reduced when vibration stops.

Then, explain an vibration welding method of the present invention. As shown in FIG. 2, hold the members 1 and 2 by the upper jig 3 and lower jig 4 and clamp them with pressure. For example, when one of the members to be welded is an air bag cover having a tear-line, driving pressure power is about 0.44 Mpa.

And, after having applied a predetermined pressure power, vibrate the upper member 1 through the upper jig 3 maintaining the pressure power. Then, the temperature of the sliding surface rises, and the rib 1r for welding begins to melt.

For example, polypropylene (PP) melting point is around 130 degrees will be used for resin materials of member 1.

The upper jig 3 and lower jig 4 come close when the rib 1r for welding melts, and the vibration by the upper jig 3 is stopped, then the vibration process is finished.

When the vibration process is finished, conventionally, a driving pressure power is maintained and cooling starts, on the other hand, in the present invention, driving pressure power is reduced and cooling starts. When one of the members is an air bag cover which has a tear-line, set the driving pressure power to 0.05˜0.35 Mpa, it is confirmed that this provides a necessary joining strength and restrains the formation of a distortion.

That is, FIG. 2 shows part of an experimental data which measured distortion on the tear-line when the members of an air bag having a tear-line were welded. FIG. 3 shows experimental data of welding strength.

It is can be seen that a large distortion after forming occurs when a pressure force of 0.44 MPa is maintained as it cools to solidity, 0.44 MPa is the same as the pressure force at the time of the vibration process.

And it can be seen that distortion after forming is reduced and that, in order to correct the malfunction that produces a visible distortion on the tear-line, 0.35 MPa is the upper limit of the pressure force that can be applied.

Also, regarding the timing of the pressure application power reduction, it is recognized that when an vibration process is finished and the pressure power is reduced immediately this can minimize distortion after forming.

On the other hand, regarding to the welding strength after forming, as shown in FIG. 4, it is recognized that the welding strength deteriorates with a fall in driving power at the time of cooling. Welding strength is satisfactory down to 0.05 MPa. However, if the driving power becomes less that 0.05 MPa unevenness can occur in the welding strength and, in some cases, it can fail to meet the welding strength requirements.

As explained above, according to the present invention, driving pressure power is reduced after the vibration process in the predetermined range.

It minimizes distortion that is easily concentrated in the weak part and it can obtain good visual quality, also, the necessary welding strength is provided.

Alternatively, the present invention is not limited to the above-mentioned embodiment. Any matter having a structure which is substantially the same as in the claims of the present invention and which are worked under the same operation belong to the technical scope of the present invention.

That is, the type of the members to be welded referred to above, i.e. an air bag, are only illustrations.

### INDUSTRIAL APPLICABILITY

When applied to an vibration welding for resin it can restrain the generation of distortion while securing the necessary strength. It can therefore, for example, be expected to be applicable to the welding process of other air-bag related parts of a vehicle.

### EXPLANATIONS OF THE LETTERS AND NUMERALS

1, 2 . . . member to be welded

1. A method of vibration welding comprising:
bringing together the surfaces of a pair of members to be welded;
melting the surfaces to be welded by pressing together the pair of members increasing driving power and generating a relative movement by simultaneous vibration;
cooling the melted portion by stopping the vibration and welding the melted portion; and
during the process of cooling, reducing the driving power to a predetermined pressure force.

2. The method of vibration welding according to claim 1, wherein the reduction of the driving power is performed as soon as the vibration has finished.

3. The method of vibration welding according to claim 1, wherein at least one of the members to be welded has a weak part in the thinnest section of the thickness.

4. The method of vibration welding according to claim 2, wherein at least one of the members to be welded has a weak part in the thinnest section of the thickness.
